(19) United States
(12) Patent Application Publication
(10) Pub. No.: US 2015/0354933 A1
(43) Pub. Date: Dec. 10, 2015

(54) CONSTRUCTION BOARD INSTALLATION

(71) Applicant: Ronnen Aten Moss, Surrey (GB)

(72) Inventor: Ronnen Aten Moss, Surrey (GB)

(21) Appl. No.: 14/126,762

(22) PCT Filed: Jun. 18, 2012
(86) PCT No.: PCT/GB2012/051394

§ 371 Date: Aug. 28, 2015

(30) Foreign Application Priority Data
Jun. 16, 2011 (GB) 1110155.7

(51) Int. Cl. G01B 3/08; E04F 21/00; E04C 2/00

(52) U.S. Cl. CPC G01B 3/08; E04C 2/00; E04F 21/00

(57) ABSTRACT

A system for guiding the installation of construction boards that includes lines marked on the boards and a fixing-point ruler and extensible section.

This invention relates to apparatus and a method that helps an installer to cut and install a construction board correctly.

### BACKGROUND

To create smooth walls, ceilings, floors, and surfaces pre-fabricated usually oblong boards are attached by an installer to wall-, ceiling-, floor-, or furniture joists. To attach them the installer puts nails, screws, bolts or other fixings through the board into pre-existing joists. The installer cannot see where the joists are when he is putting the fixing in, so he may put it through the board but miss the joist thereby failing to attach it to the joist. Furthermore, before attaching the board, the installer often has to cut the board to fit the area to be covered.

Traditionally the installer uses a pencil to put a mark on each of two opposite edges of the boards to show where the joists are or where a cut is to be made and then, using a ruler, marks a line joining these two marks.

More recently, various relevant patents have been granted or applied for: Evans—GB 2463490; Hassan—U.S. Pat. No. 4,870,788; Kellner—DE20104324; Robell—U.S. Pat. No. 6,115,926; Harris—U.S. Pat. No. 5,950,319; Buhl—DE4034460; Putz—U.S. Pat. No. 4,858,402; Martin—U.S. 2004/03506.

In general, they are about marking the boards with a grid of lines so that the installer can mark one end of the board to identify which of these lines he intends to use as a guide to fixing or cutting the board. In this way, he avoids having to mark the line on the board using a ruler and pencil.

Selecting a line takes less time and energy and the line is more likely to be in the correct position. If a cut is made in the wrong position, the whole board may have to be discarded. If a fixing is inserted that does not attach the board to the joist, it has to be removed. This removal takes time, damages the board and, if the board is being attached to a ceiling, can cause debris to fall on the installer's face.

In aggregate, these patents place markings over the whole of one or both faces of the board in the form of a grid of equidistant lines that go from each edge to the opposing edge and are orthogonal to the edges of the board.

Further markings are suggested: diagonal lines intersecting the points where the orthogonal lines cross; and a circle centred on the centre of the board whose circumference is tangential to the long edges of the board.

The orthogonal lines are spaced according to either the imperial or metric measurement standard. Some of these orthogonal lines are marked with board measurements. A grid-shaped metal ruler as large as the board, is also proposed. Some of the lines marked on the board are coloured or differentiated by style to help the installer read the markings more easily. The markings may be water-based and may fade with the light.

One face of the board may emphasise lines showing the spacing of the joists according to the local building regulations, while the other face may show the spacing of fixings according to the local building regulations. The prior art, however, tends to favour general purpose marking as construction situations are so varied.

Three problems remain.

Problem 1: Since a board has thickness, and the markings are only on the face sections of the board, they cannot be viewed immediately next to the joists. This means that, having selected a fixing line by reference to the distance between the joists, the selection cannot be easily checked for correctness when the board is placed in its intended installed position. This lack of immediate juxtaposition may mean that, if the wrong fixing line on the face section has been selected, the error is not discovered. This means the fixings inserted may not fix the board to the joists. This in turn means time and energy may be wasted inserting fixings in the wrong places and removing them.

Problem 2: When the installer selects a marked line along which to insert the fixings that attach the board to a joist, the first fixing is to be inserted a specified distance from the edge of the board and the others at a specified regular interval along the selected line. The prior art requires the installer to mark the fixing points along this line before zooming in to the task of inserting them.

According to prior art, lines at right angles to the selected line on the face of the board, measurements marked on the board, a ruler, or even a metal grid ruler laid over the board can be used as a guide as to the location of the fixing points. However, this art requires the installer to carry out two separate tasks. First, he must mark the location of the fixings and then, he must zoom in to insert the fixings.

To save time installers may just insert the fixings at what they judge by eye to be the right places. This saving may be lost due to inaccuracy that requires misplaced fixings to be removed. Also inserting fixings by eye requires a complex mental process that is more tiring than inserting them at pre-defined points.

Problem 3: Currently in order to ensure that the next fixing to be inserted can be accessed quickly and without effort, he puts screws in a fixing pouch and reaches into it to get the next fixing. This is time-consuming.

### STATEMENT OF INVENTION

According to a first aspect of the present invention there is provided a ruler comprising a plurality of parallel apertures wherein each aperture is provided a gripping means configured to releasably retain a fixing means.

Preferably the gripping means comprises a plurality of flexible members spanning each aperture.

Preferably the flexible members comprise flexible filaments.

Preferably the flexible member comprises flexible strands.

Preferably the flexible members are elasticated.

Preferably the gripping means comprises a retractable gripping means.

Preferably the rectractable gripping means comprises radially protruding splines.

Preferably the retractable gripping means comprises an aperture stop.

Preferably configured to be extensible, and/or retractable in length.

Preferably further comprising pads configured to detachably attach the ruler to a surface.

Preferably the pads comprise barbs.

Preferably the pads comprise microfibers.

Preferably the pads comprise a low tac adhesive.

According to a second aspect of the present invention there is provided a board for use in the construction industry comprising first and second planar face sections and first, second, third and four edge sections wherein at least one of the planar face sections and at least one of the edge sections are provided with corresponding parallel line markings such that the line markings on the planar face section are perpendicular to the line markings on the edge section.

According to a third aspect of the present invention there is provided a method of installing a board for use in the construction industry comprising identifying fixing points on the board using a ruler as described in relation to the first aspect of the present invention.

Preferably the board comprises first and second planar face sections and a set of parallel line markings wherein the fixing points are identified about one of the line markings.

Preferably the board comprises a board as described in relation to the second aspect of the present invention and the fixing points are identified about one of the line markings.

Preferably comprising installing a fixing means into each aperture.

Preferably comprising positioning the ruler and fixing means in position on the board and attaching the ruler to the board.

Preferably comprising fixing the fixing means in position on the board.

Preferably comprising detaching the ruler from the board.

A system comprising a board with a first planar face section and a second planar face section and four edge sections each comprising an array of line markings and a stick-on, extensible, fixing-point ruler.

The invention hereby claimed is a method of installing a board with a first planar face section and a second planar face section and four edge sections with a set of line markings on at least one face section in which the installer identifies fixing points along one of these line markings using a ruler containing a hole at each fixing point.

The installer places a fixing into each of these fixing point holes along the ruler. Each fixing is held by the ruler within its fixing point hole. The installer inserts these fixing into the board one after another. He may extend the ruler and he may stick it to the surface of the board and then remove it from the board while leaving no residue on this surface.

### ADVANTAGES

Advantage 1: The current invention allows the installer to discover the correct board fixing lines by immediately juxtaposing points on board edge section lines with points on the joist fixing lines. This means the board fixing line selection is more likely to be correct and no time is wasted measuring the distances from one joist to another

Advantage 2: Using an existing fixing on the fixing line as the zero-point or origin, the fixing-point ruler enables several further fixing points to be identified against a local set of measurements. This identification requires much smaller movements and so a much lower expenditure of energy than identifying them by reference to board-wide rulers.

Advantage 3: Because the measurements are local to the fixing points, and one fixing point is at zero, the arithmetic for calculating the next fixing point is easy. This means much less mental energy is expended.

Advantage 4: Because there is little delay between identifying the fixing point and using it to insert the fixing, the installer can leave out the task of marking the fixing point before starting to use the point to guide the fixing process.

Advantage 5: The fixing point ruler de-skills the task of placing the fixings at regular intervals along the fixing line and this means less experienced and less costly labour is involved.

Advantage 6: The installer can place a fixing in holes at intervals along the fixing-point ruler and this fixing will be held in position by the ruler until the fixing is inserted into the board. This means he can do several fixings in succession without interruption to retrieve another fixing. This production line approach is faster and less tiring for the installer.

Advantage 7: The ruler can stick to the board while it is being used to identify fixing-points. This leaves the installer with two hands free for the fixing process.

INTRODUCTION TO DRAWINGS

An embodiment of the present invention will now be described by way of example only and with reference to the accompanying drawings, in which

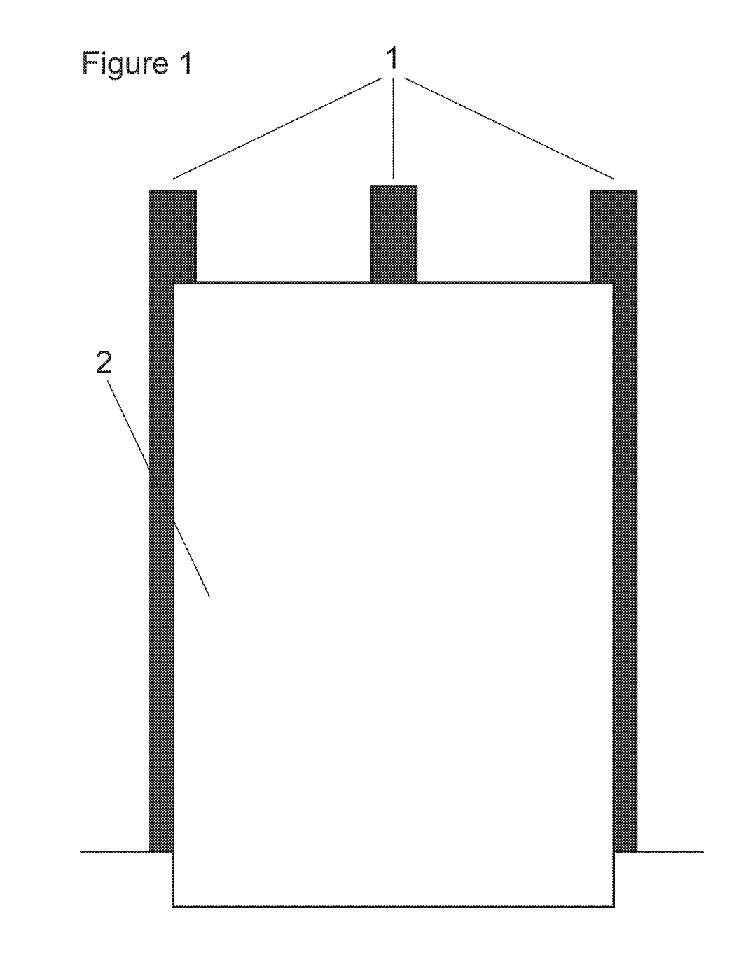

FIG. 1 shows one face section of a board that is leaning against three joists to which it is to be fixed;

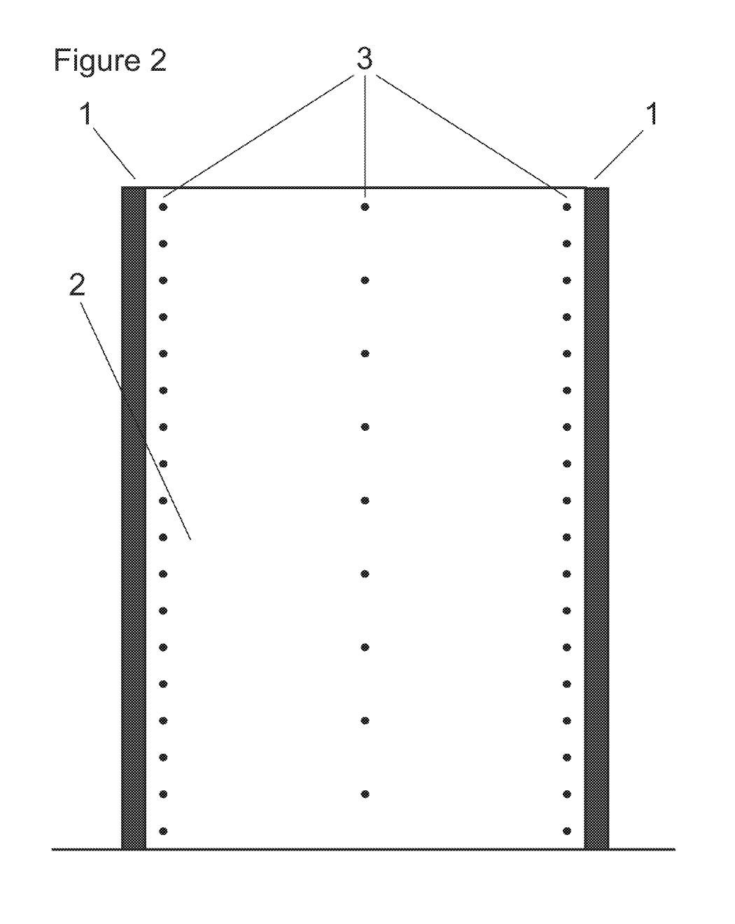

FIG. 2 shows this board fixed onto the three joists;

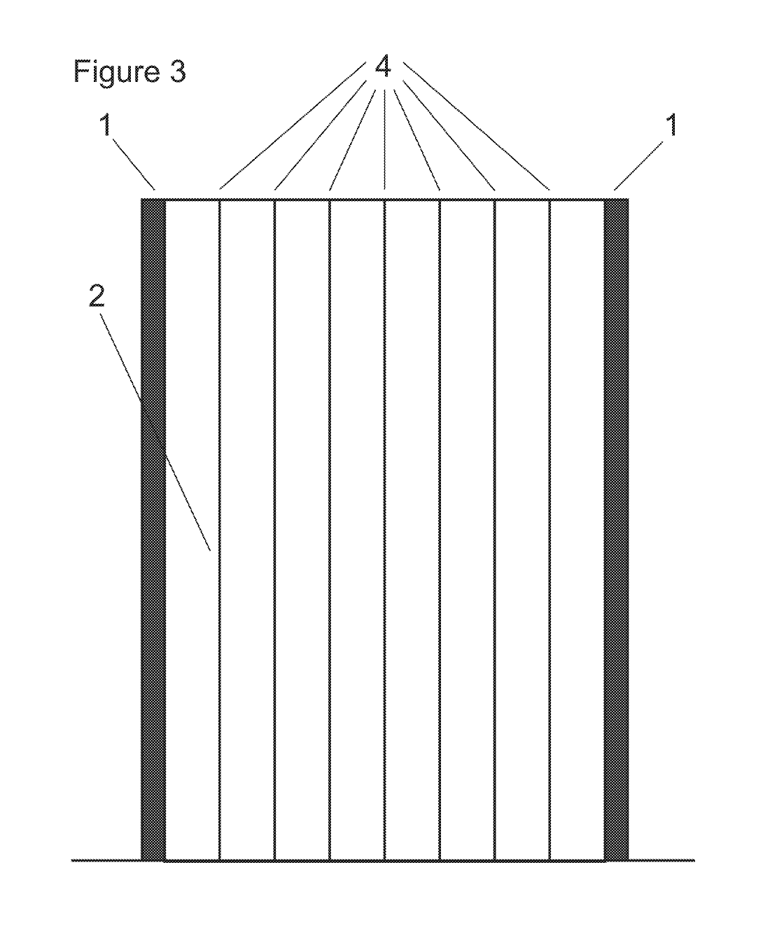

FIG. 3 shows a board in its planned installed position with vertical coloured or bold lines marked on it;

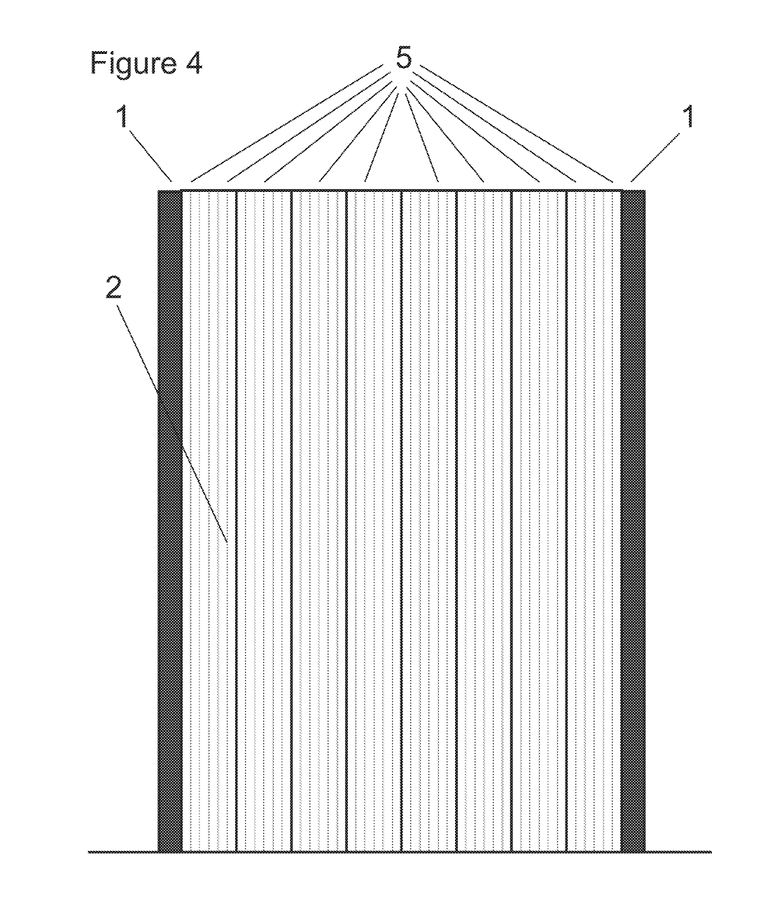

FIG. 4 shows finely spaced paler vertical lines in between the coloured or bold vertical lines shown in FIG. 3;

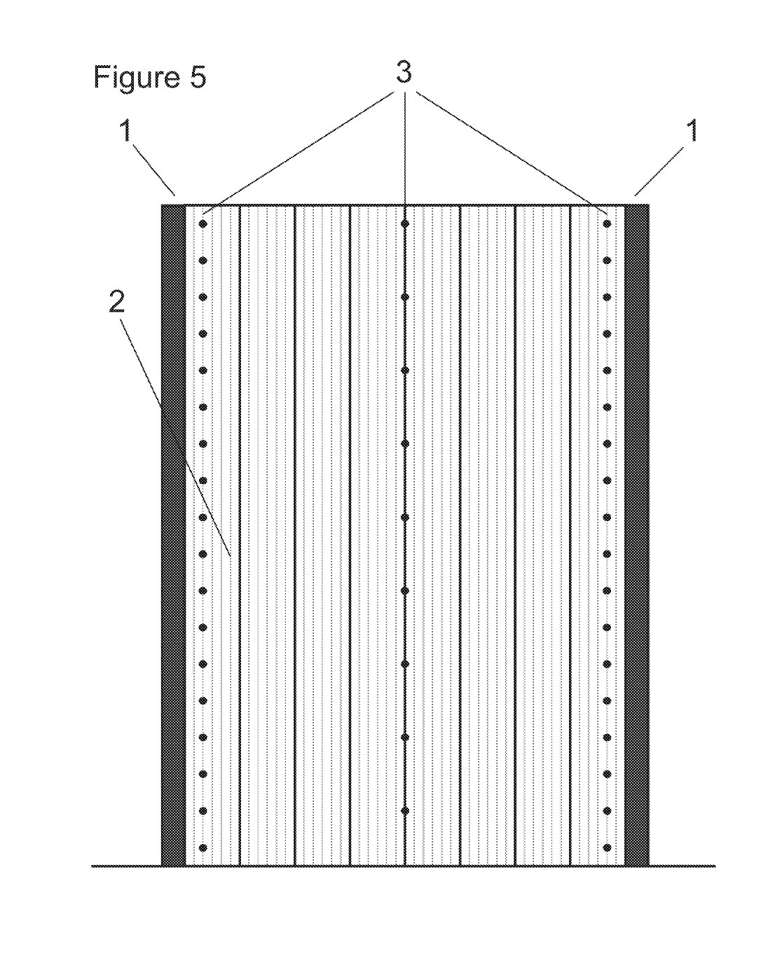

FIG. 5 shows the board with the markings shown in FIG. 4 fixed into position on the three joists by columns of regularly spaced fixings;

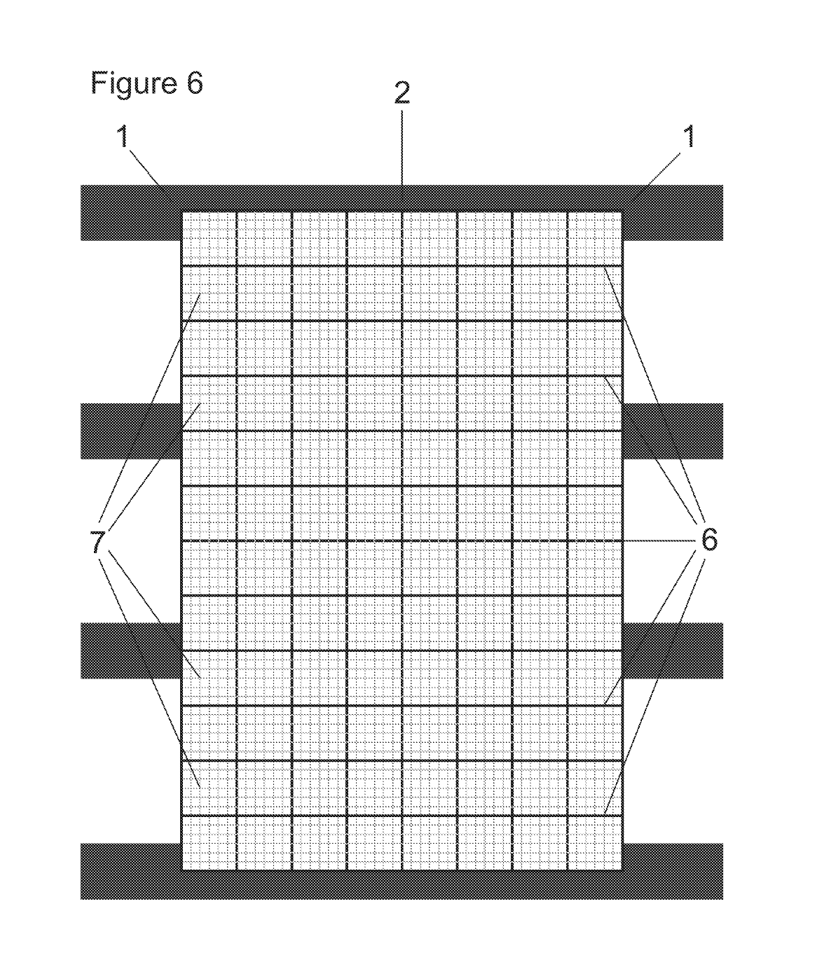

FIG. 6 shows a board with horizontal markings in the planned installed position against four joists;

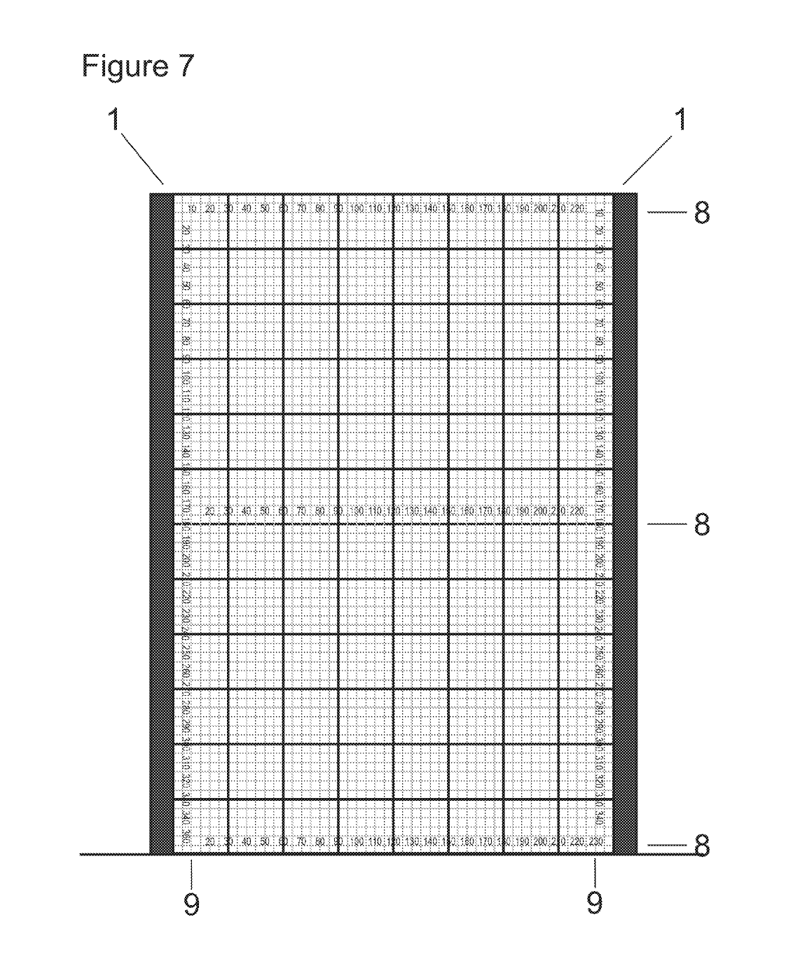

FIG. 7 shows the board with the marking shown in FIG. 6 with three rows of measurements and two columns of measurements marked on the board;

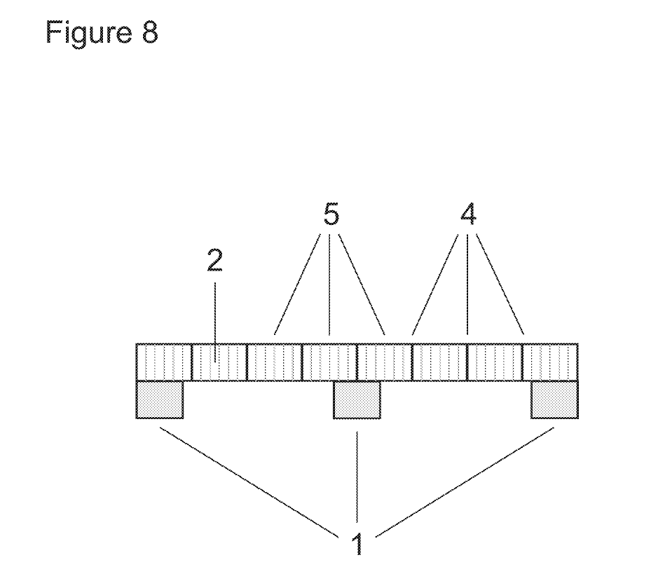

FIG. 8 shows the face section markings shown in FIG. 3 extended at right angles as markings on one edge section;

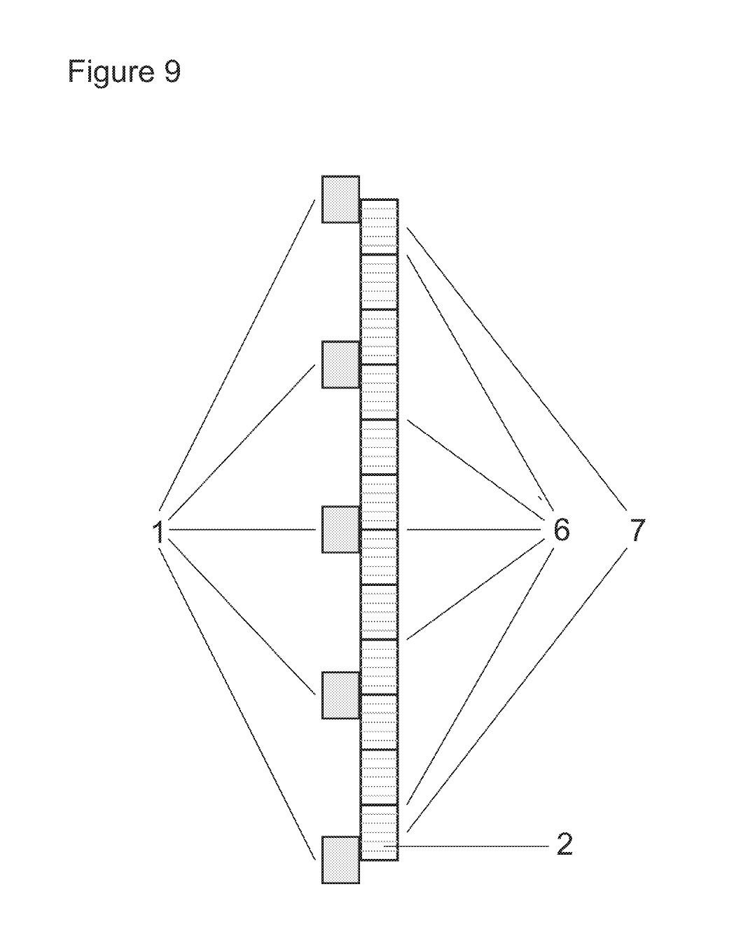

FIG. 9 shows the face section markings shown in FIG. 6 extended at right angles as markings on an edge section;

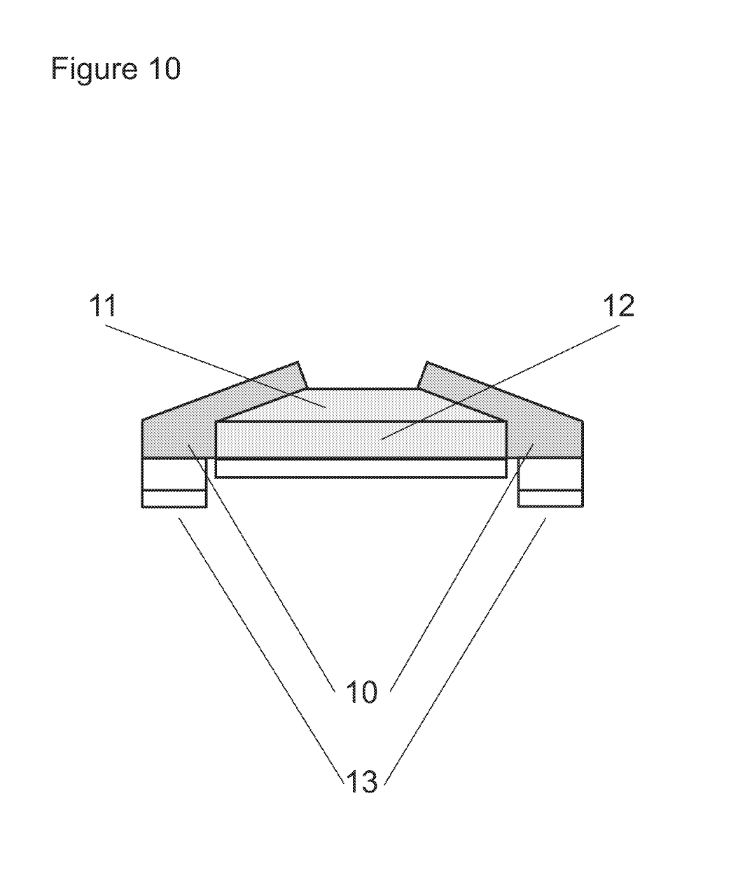

FIG. 10 shows the stick-on fixing-point ruler as viewed from its extending end;

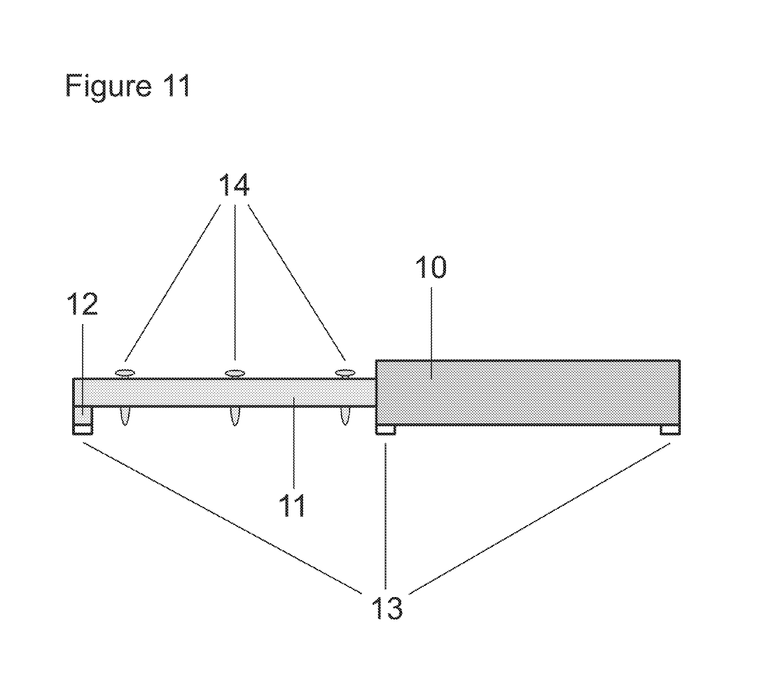

FIG. 11 shows the fixing-point ruler as viewed from one side with fixing means inserted into the ruler ready to be inserted into a board;

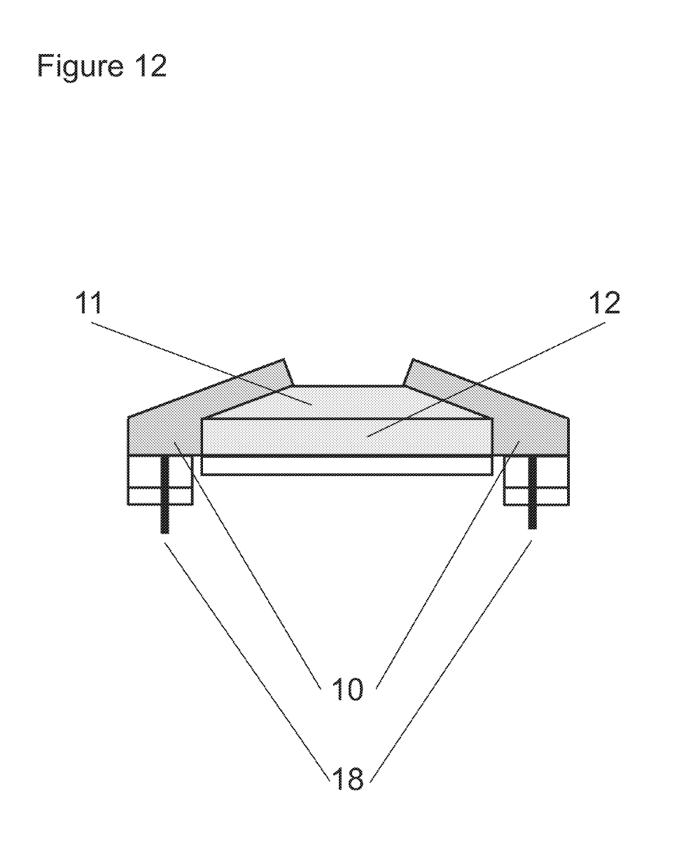

FIG. 12 shows the fixing point ruler as viewed from its extending end illustrating an example of a temporary fixing means;

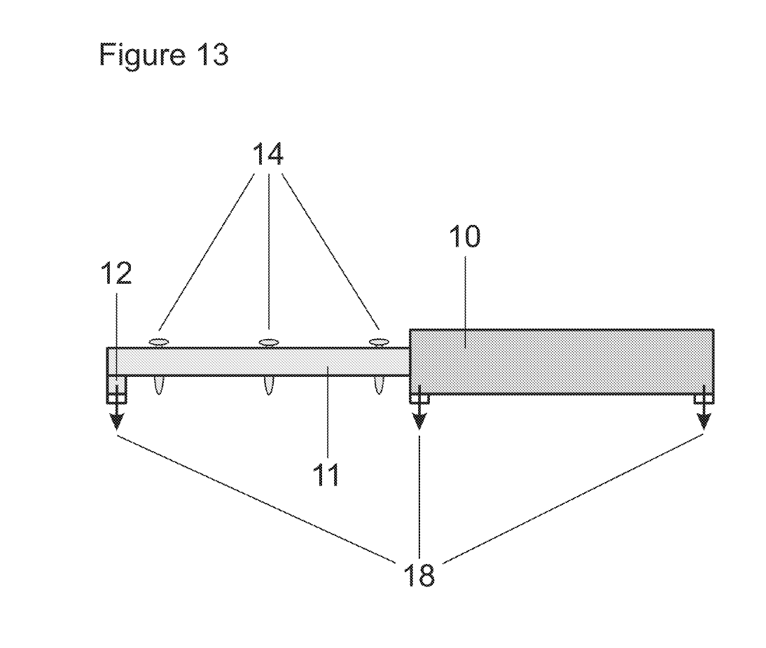

FIG. 13 shows the fixing-point ruler as viewed from one side with fixing means inserted into the ruler ready to be inserted into a board showing the direction with which the fixing means of FIG. 12 extend;

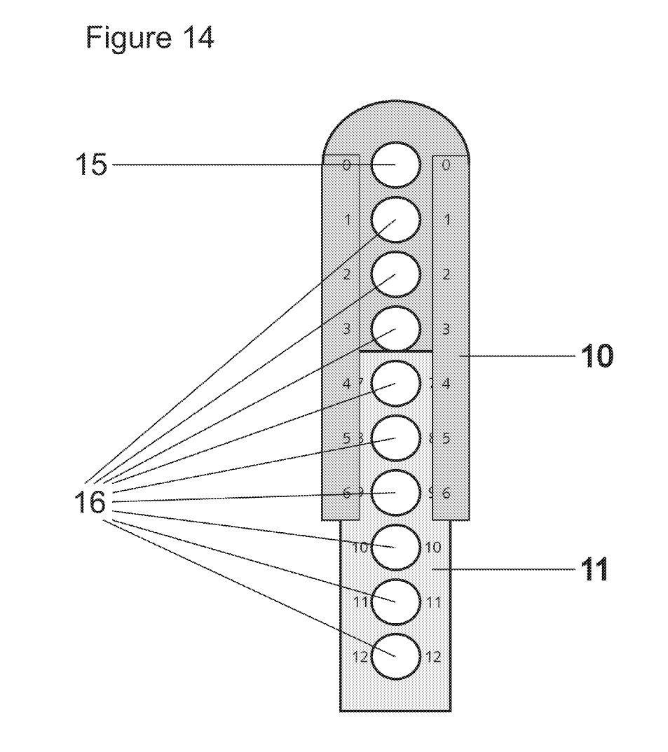

FIG. 14 shows a plan view of the fixing-point ruler with the extending part fully extended;

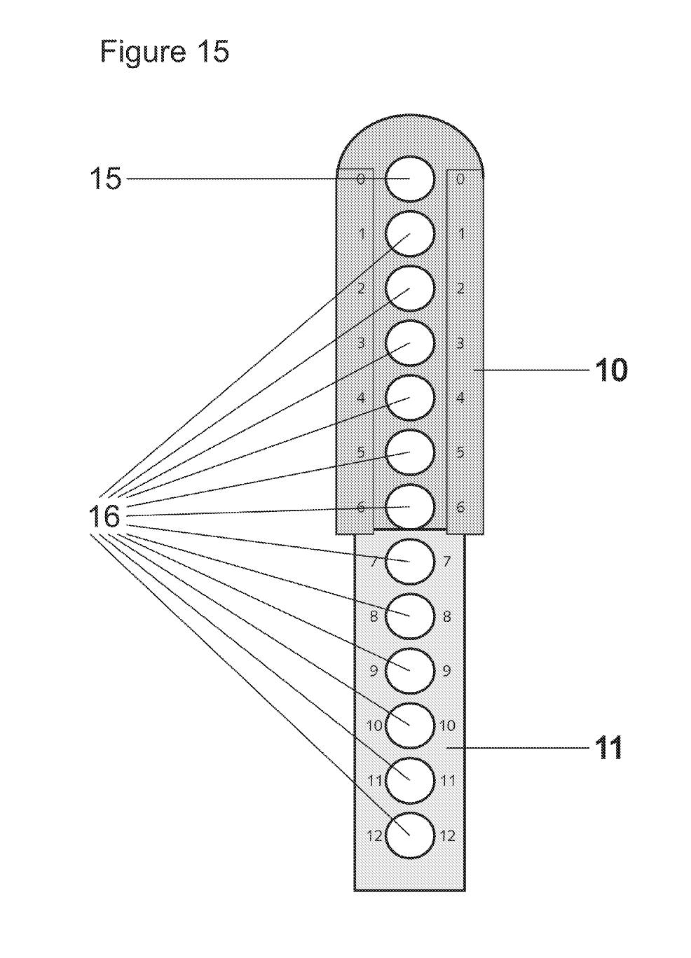

FIG. 15 shows a plan view of the fixing-point ruler with the extending part partially extended;

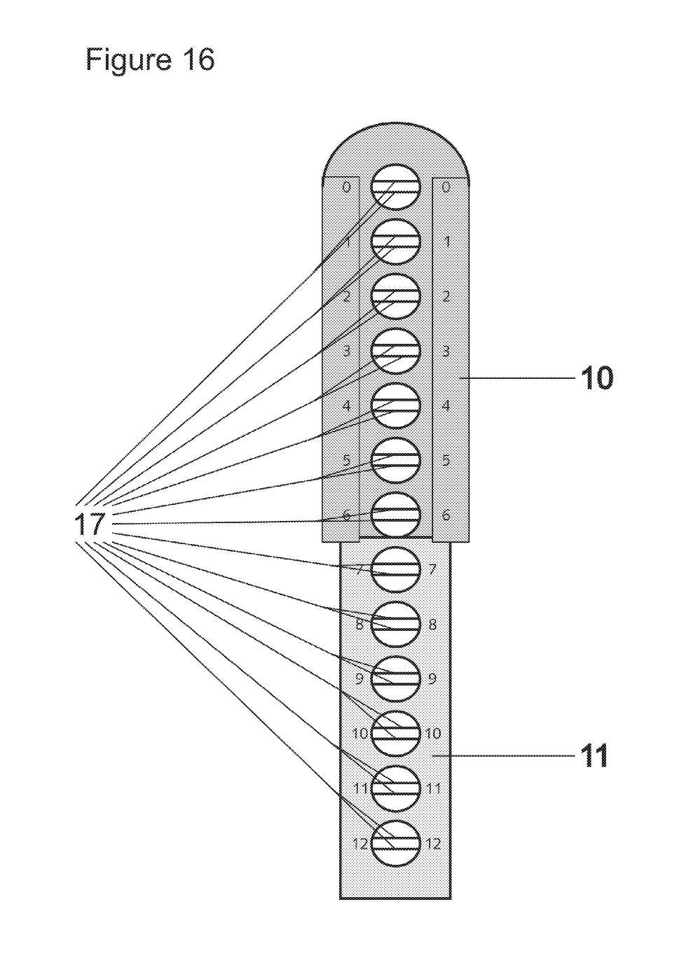

FIG. 16 shows a plan view of the fixing-point ruler with screw holders;

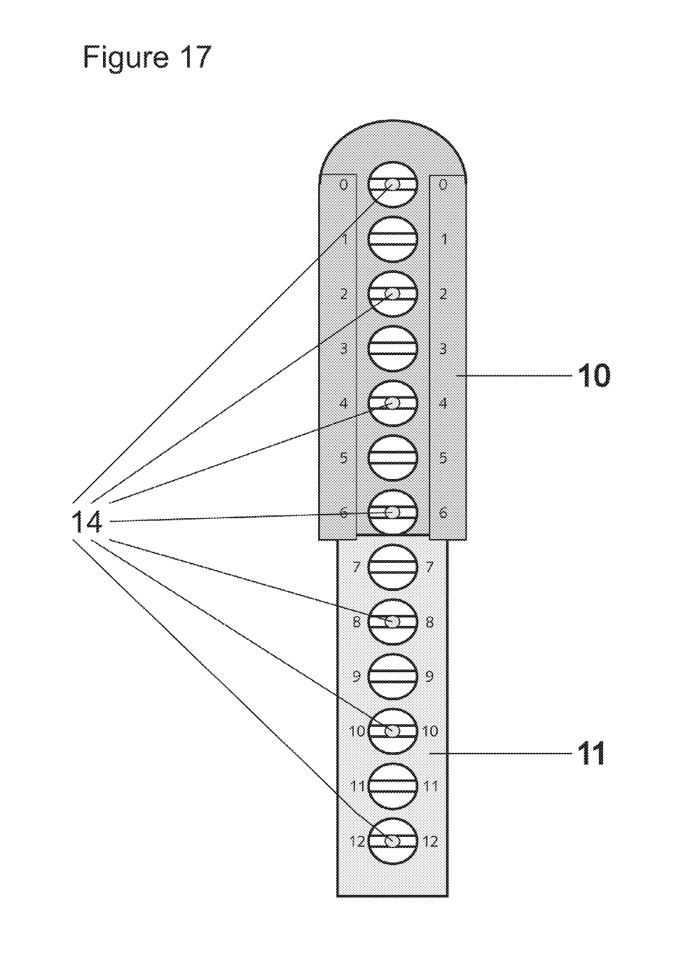

FIG. 17 shows a plan view of the fixing-point ruler with screw holders some of which contain screws;

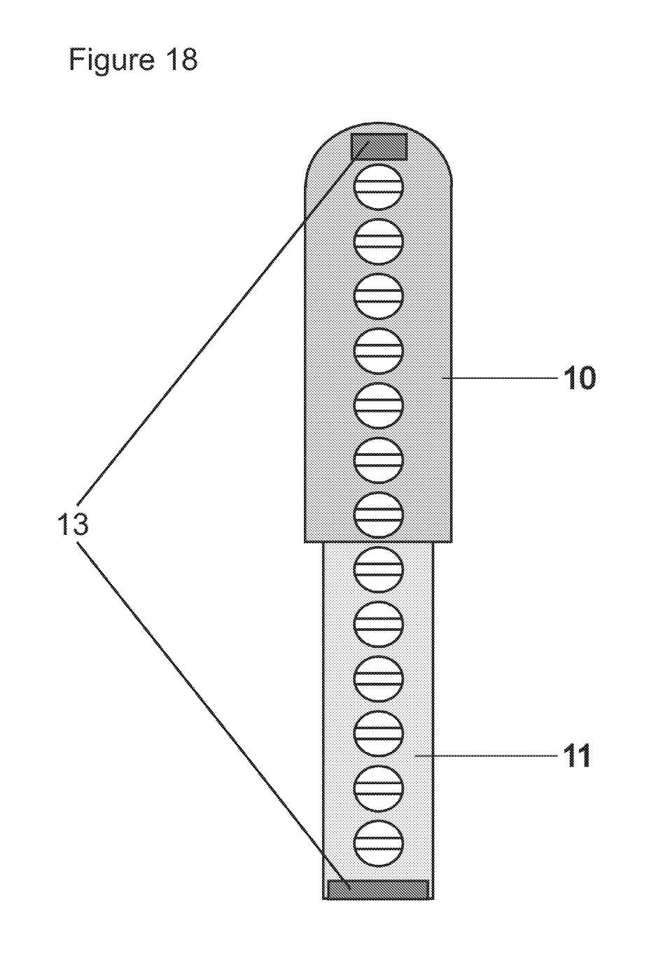

FIG. 18 shows a plan view of the underside of the fixing-point ruler; and

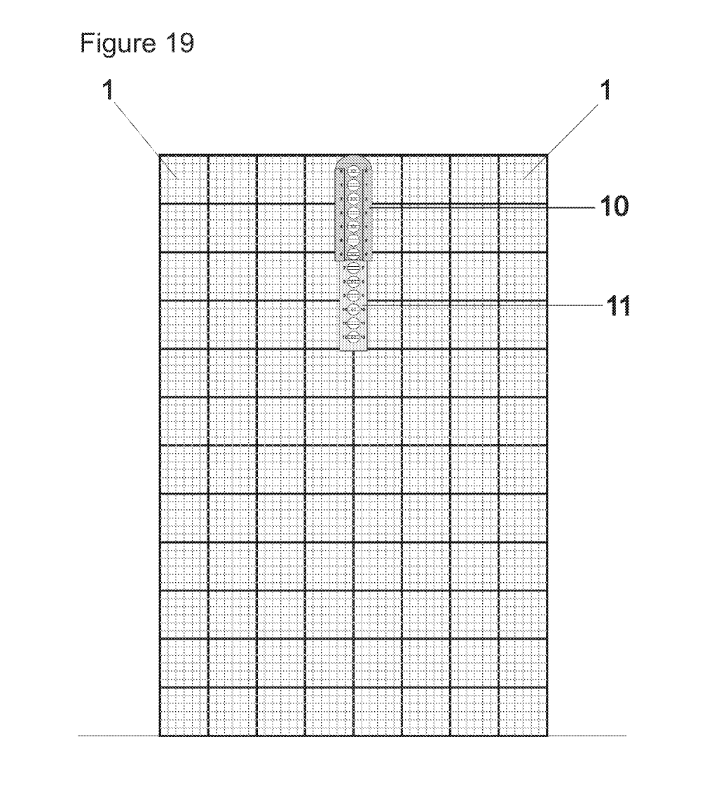

FIG. 19 shows the fixing-point ruler stuck onto to a board.

### DETAILED DESCRIPTION

An installer takes a board 2 and fixes it to joists 1 by inserting fixings 3 through the board into the joists.

To do this correctly he decides to which set of joists 1 he is going to attach a given board. He ensures that the distance between the vertical mid-lines of the end joists in this set equals the length or width of the board. If the board is too big, he cuts it to the required size. The joist fixing line set for this example comprises the innermost vertical quarter-line of each of the end-joists and the vertical mid-line of the joist that is not an end joist.

After placing the board in its planned installed position, for each member of the joist fixing line set he identifies by eye a point on a line on the edge section that is immediately juxtaposed to a point on this joist fixing line. He then extends the line he has selected on the edge section, onto a face section. In an alternative the board need not be provided with lines on the edge section and the installer simply extends by eye directly to the front face section.

He selects a line 4 or 5, if the area to be covered and the position of the joists require the board to be installed in a portrait orientation. He selects a line 6 or 7, if the area to be covered and the position of the joists require the board to be installed in a landscape orientation.

The installer now engages in the detailed work of inserting the fixings at regular intervals along each member of the board fixing line set. The installer selects a member of the board fixing line set and inserts a fixing on this line as close to the edge of the board as he requires. He then determines the regular interval that is to separate the fixings to be inserted along the fixing line. He is now ready to use the fixing-point ruler FIGS. 10 to 17. The ruler, in its un-extended state is 6 inches long. In the alternative the ruler may be fixed in length or have a small or larger unextended length as desired.

If the fixing point interval is 6 inches, the installer places the hole associated with zero inches, 15 in FIG. 12, over the first fixing and then inserts one fixing through the hole 16 opposite the 6-inch measurement mark. He then uses the fixing as a pivot point and rotates the ruler about the pivot point by 180° until the ruler again lies along the fixing line with the last fixing inserted visible through the hole at the position 16 associated with 6 inches on the ruler and inserts the next fixing in position 15 associated with 0 inches and so on until he reaches the end of the line.

If the interval is to be 1 inch longer than 6 inches, he extends the ruler by pulling the extensible section 11 out of the rigid section 10 to fit this new interval and he applies the same procedure. The fixing-point ruler can be used in this way for intervals of 7, 8, 9, 10, 11, or 12.

If the fixing point interval is shorter than six inches, say 2 inches, then he can extend the ruler fully. He then puts the hole associated with zero inches 15 over the first fixing-point and places fixings in the holes 16 associated with 2, 4, 6, 8, 10, and 12-inch measurements. He then moves the fixing-point ruler to a new position on the fixing line placing the hole opposite zero over the last fixing and then placing fixings in the holes opposite the 2, 4, 6, 8, 10, and 12-inch measurement marks and so on until the end of the line.

When he extends the fixing-point ruler to its fullest length, the leg 12 on the extensible section 11 supports it at the same level when extended as when it is retracted. In one embodiment pads 13 enable the installer to attach the fixing-point ruler to the face section of the board, the pads 13 enable the fixing-point ruler to be detachably attached to the face section of the board. In the embodiment shown in FIGS. 12 and 13 the pads are barbed metal legs 18 which fix the ruler to the board whilst still leaving a gap between the ruler and the board. In another alternative the pads are microfiber materials which act like a hook and loop type arrangement to retain the ruler on the surface of the board. In a further alternative the pads are adhesive pads with a low tac adhesive

When fixing the board in position, the installer uses a drill for example to make fixing-holes in the selected holes 16 he then places a fixing 14 into each hole. The fixing is held in position by a gripping means which in one embodiment is two slightly flexible strands 17 spanning each hole. In an alternative the fixing is held in position by a retractable gripping means. The retractable gripping means in one alternative are radially protruding splines, in another alternative are aperture stops being camera style apertures which retract back into the body of the ruler. He then uses another tool to insert the fixings.

When he is inserting the fixings, he uses one hand to hold the tool and the other hand to handle the fixings. He can do this because he attaches the fixing-point ruler to the board and detaches it when he wants to move it to a new position.

1. A ruler comprising a plurality of parallel apertures wherein each aperture is provided a gripping means configured to releasably retain a fixing means.

2. A ruler as claimed in claim 1 wherein the gripping means comprises a plurality of flexible members spanning each aperture.

3. A ruler as claimed in claim 2 wherein the flexible members comprise flexible filaments.

4. A ruler as claimed in claim 2 wherein the flexible member comprises flexible strands.

5. A ruler as claimed in claim 2 wherein the flexible members are elasticated.

6. A ruler as claimed in claim 1 wherein the gripping means comprises a retractable gripping means.

7. A ruler as claimed in claim 6 wherein the rectractable gripping means comprises radially protruding splines.

8. A ruler as claimed in claim 6 wherein the retractable gripping means comprises an aperture stop.

9. A ruler as claimed in claim 1 configured to be extensible, and/or retractable in length.

10. A ruler as claimed in claim 1 further comprising pads configured to detachably attach the ruler to a surface.

11. A ruler as claimed in claim 10 wherein the pads comprise barbs.

12. A ruler as claimed in claim 10 wherein the pads comprise microfibers.

13. A ruler as claimed in claim 10 wherein the pads comprise a low tac adhesive.

14. (canceled)

15. A board for use in the construction industry comprising first and second planar face sections and first, second, third and four edge sections wherein at least one of the planar face sections and at least one of the edge sections are provided with corresponding parallel line markings such that the line markings on the planar face section are perpendicular to the line markings on the edge section.

16. (canceled)

17. A method of installing a board for use in the construction industry comprising identifying fixing points on the board using a ruler as claimed in claim 1.

18. A method as claimed in claim 17 wherein the board comprises first and second planar face sections and a set of parallel line markings wherein the fixing points are identified about one of the line markings.

19. A method as claimed in claim 17 wherein the board comprises first and second planar face sections and first, second, third and four edge sections wherein at least one of the planar face sections and at least one of the edge sections are provided with corresponding parallel line markings such that the line markings on the planar face section are perpendicular to the line markings on the edge section and the fixing points are identified about one of the line markings.

20. A method as claimed in claim 17 comprising installing a fixing means into each aperture.

21. A method as claimed in claim 20 comprising positioning the ruler and fixing means in position on the board and attaching the ruler to the board.

22. A method as claimed in claim 21 comprising fixing the fixing means position on the board.

23. A method as claimed in claim 22 comprising detaching the ruler from the board.

24. (canceled)
